(19) United States
(12) Patent Application Publication
(10) Pub. No.: US 2015/0334258 A1
(43) Pub. Date: Nov. 19, 2015

(54) AUXILIARY PHOTOGRAPHY SYSTEMS FOR MOBILE DEVICES

(71) Applicant: olloclip, LLC, Huntington Beach, CA (US)

(72) Inventor: Patrick D. O'Neill, Huntington Beach, CA (US)

(21) Appl. No.: 14/675,535

(22) Filed: Mar. 31, 2015

Related U.S. Application Data
(60) Provisional application No. 61/974,893, filed on Apr. 3, 2014.

(51) Int. Cl. H04N 1/00; H04N 5/232; G03B 17/56

(52) U.S. Cl. CPC H04N 1/00307; G03B 17/565; G03B 17/56; H04N 5/23203

(57) ABSTRACT

In some embodiments, one or more camera systems may be removably attachable to one or more mobile devices, or the one or more camera systems may be independent from and/or non-attachable with one or more mobile electronic devices, and configured to communicate with one or more mobile electronic devices. One or more auxiliary camera systems may be used with a mobile device, such as a mobile electronic device that includes its own onboard camera system. The one or more auxiliary camera systems may include electronic sensors for capturing light, and internal electronics for processing, storing, and/or transmitting images. For example, an auxiliary camera system may be activated by a mobile device to capture and/or record an image, and may transmit the image to the mobile device.

### RELATED APPLICATION

This application claims the priority benefit of U.S. Provisional Patent Application No. 61/974,893, filed on Apr. 3, 2014, and entitled “Auxiliary Photography Systems for Mobile Devices,” the entire contents of which are hereby incorporated by reference herein and made part of this specification for all that they disclose.

### BACKGROUND OF THE INVENTIONS

1. Field of the Inventions

This invention relates generally to cameras and photography, and specifically to cameras and photography accessories and applications for mobile devices (e.g., mobile telephones, mobile texting devices, electronic tablet devices, laptop computers, desktop computers, gaming devices, and/or devices capable of linking electronically to another device or to a network such as the Internet, etc.)

2. Description of the Related Art

In recent years, many advances in computer networking and processing technology have made it possible for mobile devices to include cameras that permit users to capture images and videos. In many cases, these images and videos can be stored, processed, manipulated, and transmitted. However, there are many design constraints on onboard cameras in mobile devices that can limit the weight, size, expense, shape, adjustability, and features of such camera systems. Consequently, many cameras and related components in mobile devices are inadequate for certain photographic needs or may not otherwise provide a wide array of features.

### SUMMARY OF DISCLOSURE

Some aspects of this disclosure relate to camera systems that can be used with mobile devices to capture and/or record pictures and/or video. In some embodiments, one or more camera systems may be removably attachable to one or more mobile devices, or the one or more camera systems may be independent from and/or non-attachable with one or more mobile electronic devices, and configured to communicate with one or more mobile electronic devices. One or more auxiliary camera systems may be used with a mobile device, such as a mobile electronic device that includes its own onboard camera system. The one or more auxiliary camera systems may include electronic sensors for capturing light, and internal electronics for processing, storing, and/or transmitting images. For example, an auxiliary camera system may be activated by a mobile device to capture and/or record an image, and may transmit the image to the mobile device.

The use of a camera system that is separate from the mobile device can allow the camera to be positioned in a different location than the mobile device, allow multiple cameras to be operated by a single mobile device, provide improved or additional photographic capabilities in comparison with those provided by an onboard camera of the mobile device, and/or provide photographic capabilities for mobile devices that do not have onboard cameras, etc. For example, a separate, dedicated camera system may include a larger and/or higher quality photographic sensor than the photographic sensor of a mobile device's onboard camera. In some embodiments, a single mobile device may use its onboard camera in conjunction with, or generally simultaneously with, one or more removably attachable auxiliary cameras to record different types of images, such as multiple images from different angles, three-dimensional images, images with higher resolution than in an onboard camera in a mobile electronic device, and/or images with different levels of light filtering, magnification, polarization, light sensitivity (e.g., in the visible and/or infrared ranges), and/or aspect ratio, etc. In some embodiments, a single mobile device may control multiple separate camera systems to capture and/or record images from different angles with respect to the same subject or scene.

Some aspects of the disclosure relate to techniques for remotely activating one or more cameras, lighting, flashes, and/or other features of remote devices. In some embodiments, a camera, lighting, flash, and/or other system or device may be physically separate from a mobile electronic device (e.g., not physically connected and/or not able to communicate via a wired connection). The mobile device may activate the camera, lighting, or flash (or some other feature) by using a wireless communication connection (e.g., Bluetooth® or WiFi). In some embodiments, the mobile device may use an onboard flash or lighting component to use light to communicate with (e.g., to activate and/or control) a remote auxiliary component, such as a camera or flash device. For example, a remote camera may detect the flash from the mobile device and proceed to take a picture, trigger its own flash, and/or activate some other feature. In some embodiments, a mobile device, a remote camera, a remote flash device, or some other device may detect a user signal (e.g., a specific movement, noise, and/or gesture, etc.) by a person and trigger a responsive function, such as the capture of an image, the activation of a flash, or the activation of some other feature. In some embodiments, one mobile device may remotely activate features of one or more other mobile devices using the same or similar techniques.

Some aspects of the present disclosure relate to lighting or flash systems capable of automatically controlling and adjusting various operational parameters related to generating lighting or flashes for photography or videography. In some embodiments, a lighting or flash system may include one or more gyros, accelerometers, and/or other sensors which detect the position, movement, direction, and/or orientation of the lighting or flash system. The lighting or flash system may process information from the sensors in order to adjust the light or flash that the system generates (e.g., intensity, duration, color, etc.). In some embodiments, a lighting or flash system may include one or more adjusters, such as one or more servomechanisms (“servos”) or motors that can automatically adjust the direction in which a light or flash is to be generated. For example, the lighting or flash system may process information obtained from various sensors and automatically adjust the orientation of the flash with respect to the subject and/or camera in order to achieve better illumination of a subject or to obtain some other desired effect.

In some embodiments, a method for remotely performing one or more functions of an auxiliary photographic system can be configured to be used with a mobile communication device. For example, the method can include: (a) establishing communication between the mobile communication device and a plurality of photographic accessories and between each of the plurality of photographic accessories, wherein the plurality of photographic accessories are configured to be physically separate from the mobile communication device and to be physically separate from each other; (b) receiving, at each of the plurality of photographic accessories, one or more commands from the mobile communication device and one or more signals; (c) remotely controlling one or more operational parameters of the plurality of photographic accessories at least in part based on the one or more signals; (d) remotely performing one or more functions of the plurality photographic accessories at least in part based on the one or more commands, wherein the one or more functions of the plurality of photographic accessories are at least in part synchronized in response to the one or more commands; (e) capturing an image of a subject based on the plurality of the photographic accessories conjointly performing the one the one or more functions and controlling the one or more operational parameters; and/or (f) adjusting the orientation and/or position of the altering component relative to the subject.

In some embodiments, the method can additionally or alternatively include (a) controlling the plurality of photographic accessories based at least in part on the one or more commands from a single mobile communication device; (b) sending a command, by the mobile communication device over at least one of a wired or wireless electronic communication connection; (c) sending the one or more signals by an onboard component of the mobile communication device, wherein the one board component sends one or more signals in the form of at least one of light and sound; and/or (d) sending, by at least one of the plurality of photographic accessories, one or signals, wherein the one or more signals is a result of the at least one photographic accessory performing one or more functions.

In some embodiments, one or more of the photographic accessories can be: (a) a remote camera configured to convey photographic information to the mobile communication device; and/or (b) a photographic altering component configured to alter an image to be captured.

### BRIEF DESCRIPTION OF THE DRAWINGS

Embodiments of various inventive features will now be described with reference to the following drawings. Certain comments and descriptions are provided in the drawings as examples, but the comments and descriptions should not be understood to limit the scope of the inventions or to provide the only possible applications, structures, or usage for the illustrated examples. Throughout the drawings, reference numbers may be re-used to indicate correspondence between referenced elements. The drawings are provided to illustrate example embodiments described herein and are not intended to limit the scope of the disclosure.

FIGS. 1A-1C illustrate an embodiment of a mobile camera system.

FIGS. 1D-F illustrate embodiments of configurations of a mobile camera system and a mobile device.

FIGS. 1G-1H illustrate embodiments of a mobile camera system communicating with a mobile device or other components via wired communication.

FIGS. 1I-1J illustrate embodiments of operating a mobile camera system in communication with a mobile device.

FIGS. 2A-2E illustrates an embodiment of a remote trigger and/or control system for use with a mobile device.

FIGS. 3A-3D illustrates an embodiment of a remote camera system for use with a mobile device.

FIGS. 4A-C illustrates a mobile device communicating wirelessly with one or more other mobile devices or mobile components to control and/or to coordinate various functions of the one or more mobile devices and/or components.

FIG. 5A illustrates a mobile device configured to respond to one or more user signals.

FIG. 5B is a flow diagram of an illustrative process for responding to one or more user signals.

FIGS. 6A-6O illustrates an embodiment of a lighting or flash system.

FIGS. 7A-7F illustrates example uses of a lighting or flash system.

FIGS. 8A-8B illustrate examples of adjusting an operating parameter of a lighting or flash system based on a photographic subject.

FIGS. 9A-9O illustrates another embodiment of a lighting or flash system.

### DETAILED DESCRIPTION OF EMBODIMENTS

The present disclosure relates generally to auxiliary photography systems for mobile devices, such as cameras, lighting, flashes, and/or programming instructions or applications for mobile devices, etc. Mobile electronic devices are mobile devices with electronic capabilities. Mobile communication devices are mobile electronic devices that are capable of communicating remotely, either in a wired or wireless manner, with another electronic device. Many different structures, features, steps, and processes are shown and/or described in discrete embodiments for convenience, but any structure, feature, step, or process disclosed herein in one embodiment can be used separately or combined with or used instead of any other structure, feature, step, or process disclosed in any other embodiment. Also, no structure, feature, step, or processes disclosed herein is essential or indispensable; any may be omitted in some embodiments.

The terms “mobile electronic devices” and “mobile devices” in this specification are used in their ordinary sense, and include mobile telephones, mobile texting devices, media players, electronic tablet devices, laptop computers, desktop computers, gaming devices, wearable electronic devices (e.g., “smart watches” or “smart eyewear”), and/or mobile electronic communication devices capable of linking electronically to another device or to a network such as the Internet, etc. Some mobile electronic devices include one or more onboard cameras that can be used for various imaging purposes, such as photography and video recording. In addition, some mobile electronic devices include one or more illumination components, such as one or more lights, and/or flashes, etc., that can be used for photography, videography, and/or other purposes (e.g., as a flash light).

The term “camera” in this specification is used in its ordinary sense, and includes cameras configured for still photography, videography, or both. The cameras described herein may include one or more different lenses, or may be used with one or more auxiliary lenses. In addition, the cameras described herein may include or be configured for use with one or more illumination sources, such as lights and/or flashes.

The terms “flash” and “flash component” in this speciation are used in their ordinary sense, and generally refer to electronic flash units that include LEDs, xenon-based bulbs, or other illumination sources. Each time this specification refers to “flash,” or any related or similar term, it should also be understood to refer to and encompass, either additionally or alternatively, a light source of any type, such as a pulsating light, or a generally constant light source, or a long-duration light source.

The term “lens” in this specification is used in its ordinary sense, and includes powered lenses (e.g., lenses that focus, magnify, enlarge, or otherwise alter the direction of light passing through the lens), plano lenses (e.g., lenses that are generally planar, lenses that do not taper in thickness, and/or lenses that are not powered), simple lenses, compound lenses, generally spherical lenses, generally toroidal lenses, generally cylindrical lenses, etc. Any imaging device described or illustrated in this specification can include a retainer attached to one or more lenses or optical regions with one or more different features, including but not limited to a constant or variable magnifying lens, a wide-angle lens, a fish-eye lens, a telescopic lens, a macro lens, a constant or variable polarizing lens, an anti-reflection lens, a contrast-enhancing lens, a light-attenuating lens, a colored lens, or any combination of the foregoing, etc.

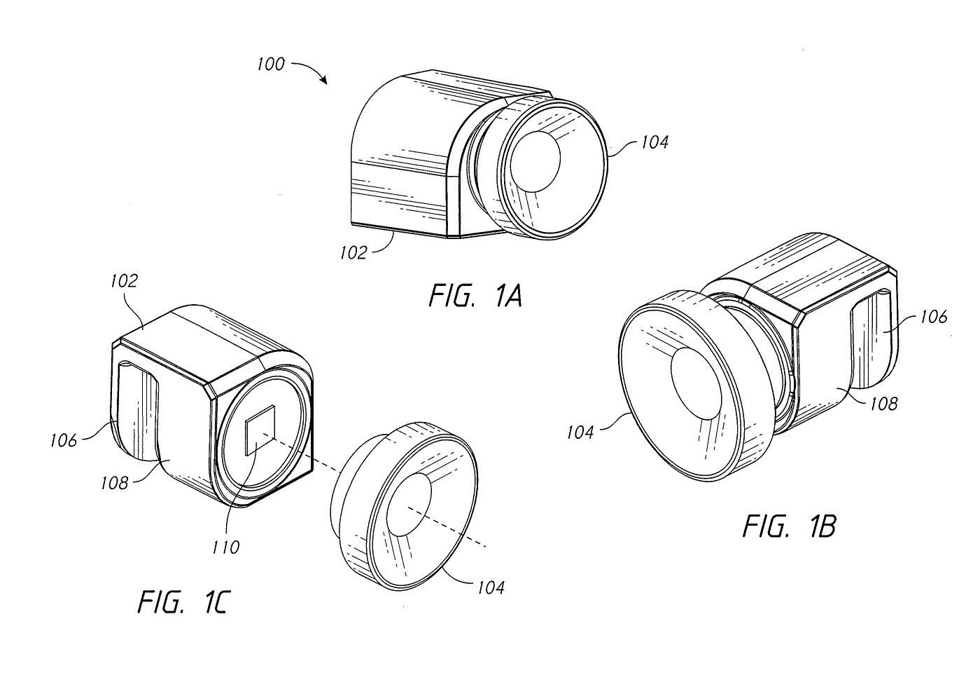

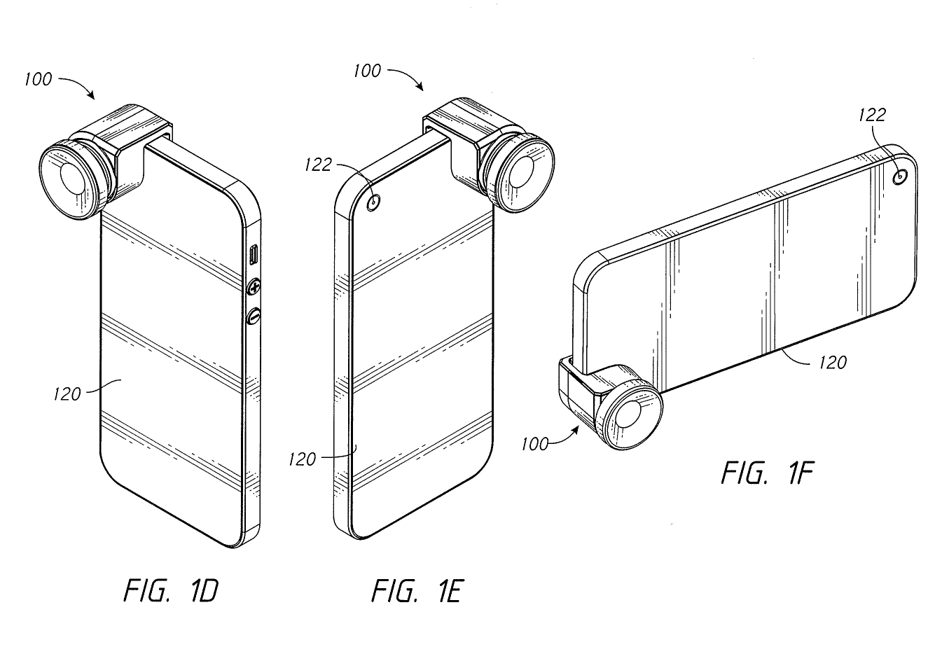

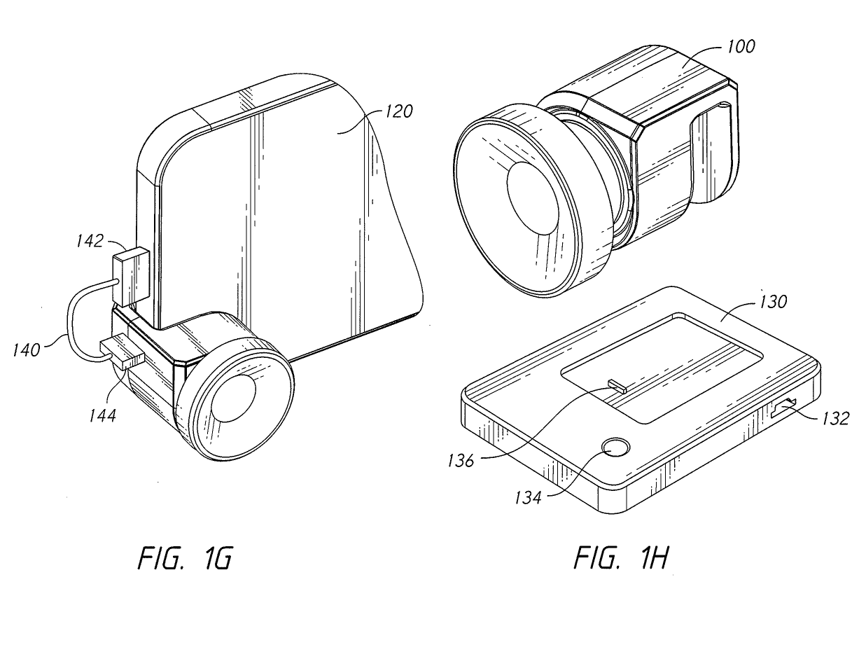

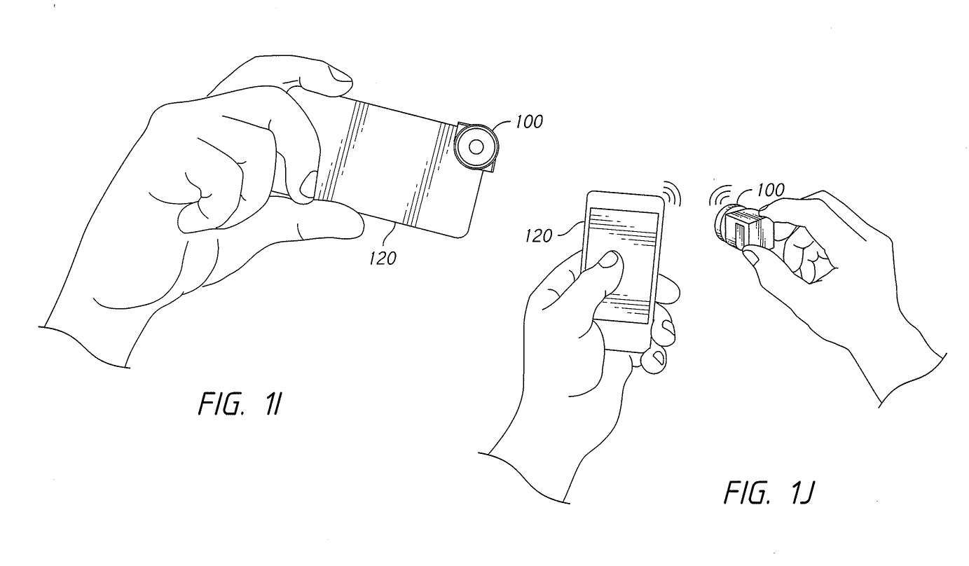

Referring to FIGS. 1A and 1H, illustrative embodiments of a removably attachable camera system 100 for a mobile device 120 are shown. In some embodiments, a mobile device 120 can control the camera system 100 wirelessly, as depicted in FIGS. 1D-1F, 1I and 1J (or via a wired connection, as depicted in FIG. 1G), such as to capture and/or record photos, videos, sound, etc., on demand. The mobile device 120 can control the camera system 100 to capture and/or record photos on a timer or in response to some event (e.g., detection of a sound, detection of a light flash), to transfer recorded images, sound, and/or other data to the mobile device 120 or some other device, to power the camera system 100 on and off, etc.

In some embodiments, as illustrated in FIGS. 1A-1C, the camera system 100 may include a retainer portion 102 with one or more attachment regions (e.g., side walls 106 and 108, as described in more detail below) for removably or permanently attaching one or more lenses 104 lenses to the retainer. The camera system 100 may also include a sensor 110 for capturing light (e.g., light received from or transmitted by a lens 104) and recording images. As shown, the sensor 110 may be coupled to the retainer 102, and may be optically aligned with a lens 104 that is removably or permanently attached to the retainer 102. In some embodiments, the camera system 100 may include a microphone (not shown) for recording sound in conjunction with, or independently from, recording video.

The retainer 102 or some other portion of the camera system 100 may include or contain circuitry and/or other electronics (not shown) for providing additional features, such as storage of the images captured by the sensor 110, processing of the images, transmission of the images and/or any other data to a computer, to a mobile device 120, to a memory, and/or to another camera system 100, via wired or wireless communication with the mobile device 120 and/or other devices, etc. In some embodiments, the camera system 100 may include a removable memory module (not shown), such as a flash memory module, that can be read by a mobile device 120 or other computing device, exchanged with other camera systems 100, replaced with other memory modules of the same or different storage capacity, etc. The retainer 102 or some other portion of the camera system 100 may also contain or include a battery for powering the sensor 110 and other electronics.

The retainer 102 may include first and second sidewalls 106, 108 that are sized, shaped, and/or oriented to removably attach the camera system 100 to a mobile device 120. For example, as illustrated in FIGS. 1D-1F, the first and second sidewalls 106, 108 may form a channel into which a portion (e.g., a corner portion) of a mobile device 120 may be inserted. The sidewalls 106, 108 may secure the camera system 100 to the mobile device 120 using a friction fit, by “pinching” the mobile device 120, etc. In some embodiments, the retainer 102 may extend less than the entire length of one or more edges of the mobile device 120 onto which it is installed, minimizing the amount of the mobile device 120 that is obstructed when the camera system is installed. In addition, the relatively small size of the camera system 100 in comparison with the mobile device 120 enhances portability. For example, the entire camera system 100 may be substantially smaller than a face of the mobile device 120 to which it is attached (e.g., in some embodiments covering only a corner region or only an edge region of the mobile device 120), and/or small enough to be carried in a user's pocket, on a user's key ring, etc. Some embodiments of the retainer 102 or camera system 100 may incorporate or use any of the various structures, features, and/or methods described in U.S. Pat. No. 8,279,544, titled “Selectively Attachable and Removable Lenses for Mobile Devices,” which issued on Oct. 2, 2012, the contents of which are hereby incorporated by reference in its entirety.

FIGS. 1D-1F illustrate that the camera system 100 may be used with a mobile device 120 in multiple orientations or positions. For example, the mobile device 120 can be pivoted, flipped, or rotated, and then the camera system 100 can be attached to the mobile device 120 in multiple positions. The camera system 100 may be positioned in particular orientations or positions for user comfort and ease of use. For example, the camera system 100 and mobile device 100 may be configured in such a way that a user may operate the combined configuration while the mobile device 120 is in a portrait orientation (e.g., larger vertical dimension than horizontal dimension), as shown in FIGS. 1D and 1E. Alternatively, the camera system 100 and mobile device 100 may be configured in such a way that a user may operate the combined configuration while the mobile device 120 is in a landscape orientation (e.g., larger horizontal dimension than vertical dimension), as shown in FIG. 1F.

Some mobile devices 120, as shown in FIGS. 1E and 1F, may include an onboard camera 122. The camera system 100 may be installed onto the mobile device 120 such that the onboard camera 122 is partially or completely obstructed by the camera system 100, as illustrated in FIG. 1D. In such cases, the camera system 100 may effectively temporarily replace the onboard camera 122, such as when the camera system 100 includes a larger, higher-resolution, and/or higher-quality sensor 110, a lens 104 configured to provide one or more desired visual or optical effects or features (such as any optical or visual effects or features described elsewhere in this specification). In some embodiments, as shown in FIGS. 1E and 1F, the camera system 100 may also or alternatively be installed onto the mobile device 120 such that the onboard camera 122 of the mobile device 120 is not obstructed. For example, the camera system 100 may be installed onto a different side, corner, or other portion of the mobile device 120 than the onboard camera 122. In this configuration, the camera system 100 may be used in conjunction with the onboard camera 122, such as to capture and/or record images from different positions or angles with respect to a subject, or with different photographic effects or attributes (such as any optical effects or features described elsewhere in this specification). In some embodiments, the images may then be combined by the camera system 100, mobile device 120, and/or some other device for any suitable purposes, such as to form three dimensional images.

Referring to FIG. 1G, the camera system 100 may communicate with the mobile device 120 via a wired connection, such as a data and/or power cable 140. In such cases, the camera system 100 may include a port 144, such as a mini USB port, a micro USB port, a Lightning® port, or the like. The cable 140 can be coupled to the port 144 of the camera system 100 and a port 142 of the mobile device 120 to facilitate wired electronic communication of data and/or transfer of electronic power. In some embodiments, as shown in FIG. 1H, a dock 130 may be used to charge the battery of the camera system 100, transfer data to and/or from a mobile device or other computing device, and the like. Dock 130 may include a data or power connecter 136 for accepting an electrical connection with camera system 100, such that data may be transferred between dock 130 and camera system 100 or dock 130 may supply power to the batter of camera system 100. A data or power connector port 132 may be included for accepting a cable or other connection to an external source (e.g., a personal computer, laptop or the like for exchanging of data or an external power source, such as a wall outlet or the like for supplying power to the battery of camera system 100). In some embodiments, dock 130 may include an indicator 134 such as a light (e.g., an LED), a speaker, and/or a screen, for indicating statuses and/or other information. The indicator 134 may be indicative of an electrical connection between the camera system 100 and dock 130, a recharge complete status of the battery of the camera system 100, a data transfer status, or any status of electrical communication between the camera system 100 and dock 130 and/or an external unit (not shown).

Referring to FIGS. 1I and 1J, the camera system 100 may be controlled by or otherwise communicate with the mobile device 120. The camera system 100 may include a wireless communication module (not shown) to facilitate wireless communication with a mobile device 120 (e.g., via Bluetooth® or WiFi), and a user may use the mobile device 120 to activate or program the camera system 100 to perform functions of the camera system 100. For example, a user may set up the camera system 100 at a particular location from which photographs are desired, and that location may be physically separate or remote from the user's mobile device 120, as illustrated in FIG. 1J. As illustrated in FIG. 1I, the user may also attach the camera system 100, as described in reference to FIGS. 1D-1F, and maintain communication with the mobile device 120 without the need of a wired connection.

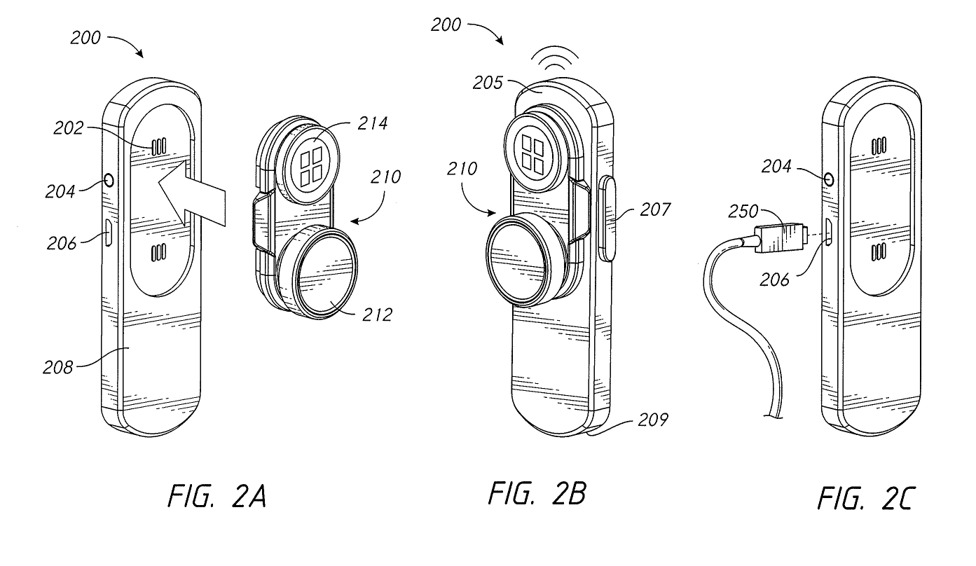

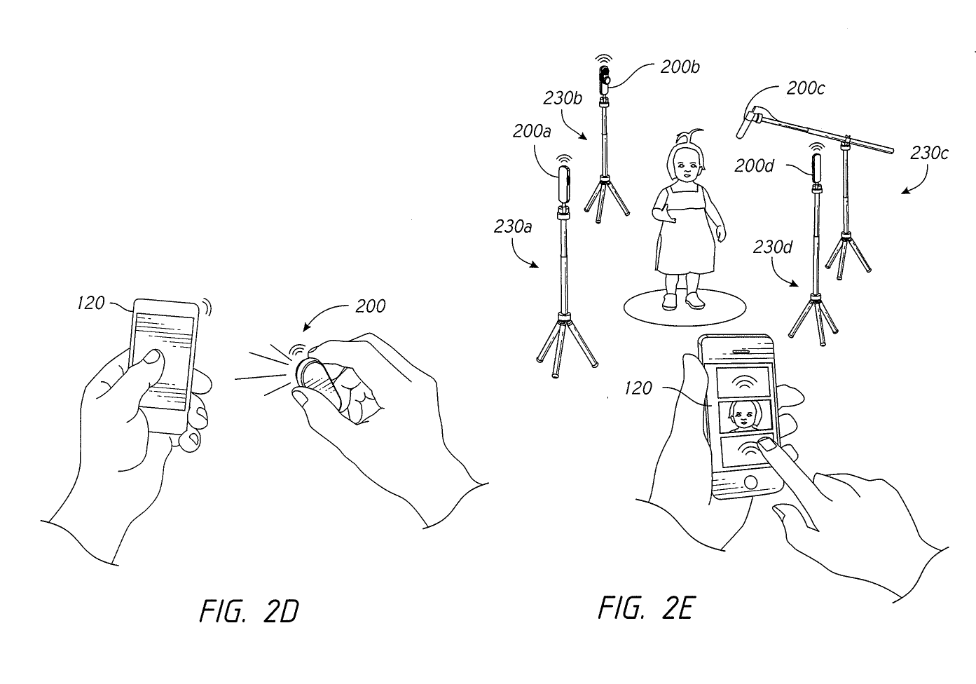

FIGS. 2A-2E shows embodiments of a remote base, such as a remote trigger system 200, that may be controlled by or otherwise communicate with a mobile device 120. As shown in FIGS. 2A and 2B, various modular devices, for example module device 210 having a camera component 212 and a flash component 214, may be attached to the remote trigger system 200, and the remote trigger system 200 can facilitate remote activation or control of the modular devices by a mobile device 120. In some embodiments, as illustrated in FIG. 2E and as explained in more detail below, the modular devices may include two or more separable modular components, such as a camera device, a lighting device, a flash device, and/or a microphone, and/or some combination thereof, etc. The remote trigger system 200 may include a wireless communication module 205 to facilitate wireless communication with a mobile device 120 (e.g., via Bluetooth® or WiFi), and a user may use the mobile device 120 to activate or program the modular device(s) attached to the remote trigger system 200, as illustrated in FIG. 2D. For example, a user may set up the remote trigger system 200 at a particular location from which photographs are desired, and that location may be physically separate or remote from the user's mobile device 120. The user may attach a modular camera device 210 to the remote trigger system 200. The remote trigger system 200 can then activate and use features of the modular camera device 210 (or other modular device disclosed and/or illustrated in this specification, or any other features) according to the commands received from the mobile device 120 (e.g., take pictures on-demand, according to a pre-set timer, in response to an input or other event, etc.).

A software application may be installed on or provided with a mobile device 120 for controlling the remote base or remote trigger system 200. The application may allow users to control one or more remote trigger systems 200, access individual features and settings of the modular devices attached to the remote trigger systems 200, receive data (e.g., images, sound) from the remote trigger systems 200, etc.

In some embodiments, as shown in FIGS. 2A and 2B, the remote base or the remote trigger system 200 may include one or more wired electronic contacts 202 for communicating with modular devices when the devices are attached to the remote trigger system 200. The remote trigger system 200 may also include one or more indicator components 204, such as a light (e.g., an LED), a speaker, and/or a screen, for indicating statuses and/or other information. The remote trigger system 200 may include a wireless communication module to facilitate wireless communication with device 120 and/or other remote trigger systems. The remote trigger system 200 may further include an internal battery 208 for powering the components described above, the corresponding internal circuitry, and the modular devices attached to the remote trigger system 200. The remote trigger system 200 may also include, as shown in FIG. 2C, one or more data ports 206, such as AC power ports, DC power ports, network ports, mini USB ports, micro USB ports, Lightning® ports, headphone jacks, and the like to recharge the internal battery 208 and/or to facilitate wired communication using a cable 250.

In some embodiments, the remote trigger system 200 may include a trigger input 207, such as button or touch sensitive surface to enable a user to activate the features of the remote trigger system 200 independently of the mobile device 120. In some embodiments, the application provided with mobile device 120 may be configured to allow users to control one or more remote trigger systems 200 via a single remove trigger system 200. For example, the application of mobile device 120 may allow users to synchronize multiple remote trigger systems to a trigger input 207 of a one remote trigger system 200. In this way, a user may be able to operate one or more remote trigger systems while physically separated from the mobile device 120.

The remote trigger system 200 may be shaped and/or sized to provide a highly portable base and/or remote trigger system for use with mobile devices 120. For example, the remote trigger system 200 may be substantially narrower, shorter, and/or thinner than the typical mobile device with which it is used (e.g., less than or equal to about half as wide and/or less than or equal to about half as tall as a mobile phone). This size can allow one or more remote trigger systems 200 to be carried more easily in a user's hand or pocket, mounted in a wide range of locations, etc. In addition or alternatively, the remote trigger system 200 may include components 209 that facilitate mounting on traditional tripods and other photographic mounts. Modular devices may be configured to work with the remote trigger system 200 by removably attaching to the remote trigger system 200 using a friction fit, a snap-on attachment, or any other attachment mechanism. The modular devices may electronically communicate with the remote trigger system 200, such as via electronic contacts on the modular device and corresponding electrical contacts 202 on the remote trigger system 200, via a cable coupled to a port 206 of the remote trigger system 200, or wirelessly, depending upon the configuration and capabilities of the remote trigger system 200, the specific modular devices, and/or the wishes of a user. An indicator component 204 can provide information and feedback to a user regarding the state of the remote trigger system, the state of the attached modular devices, the operation of the modular devices, state of wired or wireless connectivity between remote trigger system, module device and/or mobile device, etc. For example, a modular device may be activated by a mobile device 120 to perform a particular function (e.g., capturing a photograph), and the indicator component 204 can flash or change color to indicate success or failure.

Different modular devices may provide one or more of a variety of different features, including photography, lighting, and/or sound capture, and the like. In some embodiments, as shown in FIGS. 2A and 2B, a modular device 210 may include a camera component 212 and a flash component 214. The camera component 212 may include an electronic sensor (not shown) for capturing images, and a lens for transmitting light to the sensor and optionally modifying the light. In some embodiments, the camera component 212 may be configured to receive various removably attachable lenses, such as lenses configured to magnify, darken, filter, or otherwise alter light based on the wishes of the user. The individual removably attachable lenses may be coupled to the camera module 210 or remote trigger system 200 as described above or according to any attachment mechanism known to those of skill in the art. The flash component 214 may also or alternatively be configured to receive various removably attachable flash elements, such as flash elements capable of emitting light with different colors, intensities, and the like.

In some embodiments, as shown in FIG. 2E, a single mobile device 120 may control, either directly or indirectly, multiple (e.g., two or more) separate remote base or remote trigger systems. For example, as shown, a user may use a mobile device 120 to control multiple remote base or remote trigger systems 200A, 200B, 200C, and 200D to which various combinations of modular devices have been coupled, including but not limited to one or more: lighting modules, camera modules, flash modules, microphone modules, and/or static lighting modules, etc. In some embodiments, a single remote trigger system 200 may be controlled by multiple separate mobile devices 120. For example, a single remote trigger system 200 to which a camera module has been coupled may be controlled by multiple mobile devices, in some cases generally simultaneously (e.g., one user may use a mobile device 120 to instruct the remote trigger system 200 to record video of a subject, and a second user may use a second mobile device 120 to instruct the same remote trigger system 200 to capture a still image of the subject at the same time). In some embodiments, remote base or remote trigger systems 200 may communicate with each other to exchange data, share connections, and/or synchronize operation, etc.

In some embodiments, a plurality of remote base modules or remote triggers systems 200 in communication with a mobile device 120, can each be attached electronically and/or physically (either unitarily or removably) to one or more information-capturing devices and/or one or more visual effect devices (e.g., one or more: cameras, microphones, lighting, and/or flash devices), or a mobile device 120 can be in direct electrical communication (wired or wireless) with one or more information-capturing and/or visual effect devices, in such a way that generally simultaneous information feeds (e.g., one or more different video, photo, and/or sound feeds) can be provided at about the same time to the mobile device 120 from the same scene and/or the same subject, as illustrated, to accomplish real-time or near-real-time multiplexing from different data sources. In some embodiments, the screen of the mobile device 120 can be configured, such as by an application, to display multiple, generally simultaneous images (e.g., photo or video) from different viewpoints and/or angles at about the same time. In some embodiments, the mobile device 120 can be configured to continuously choose from among a plurality of different photographic (e.g., photo or video) feeds to record and store a real-time or near-real-time collection of images.

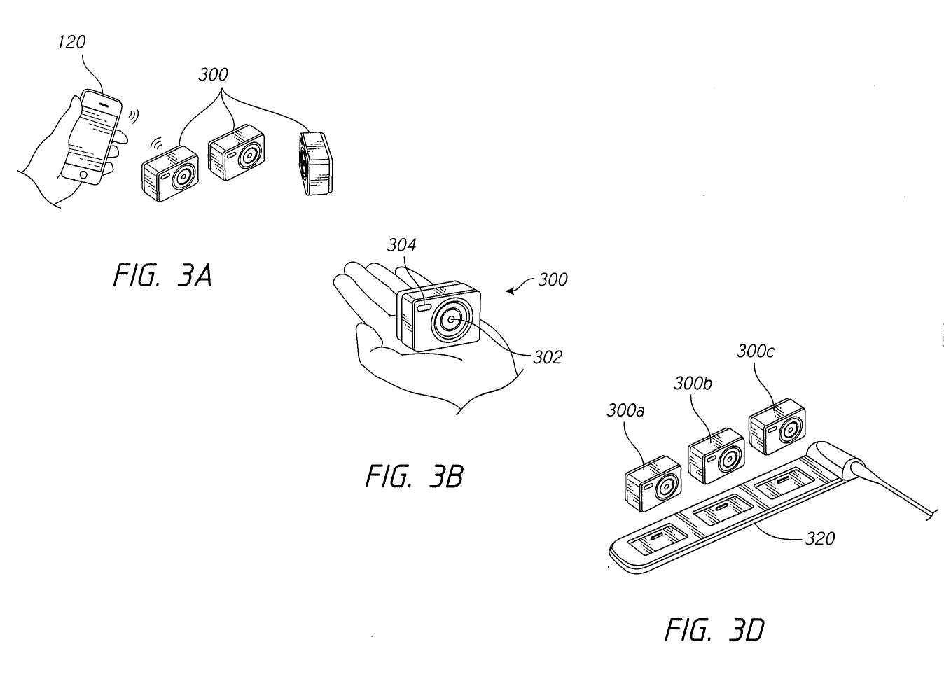

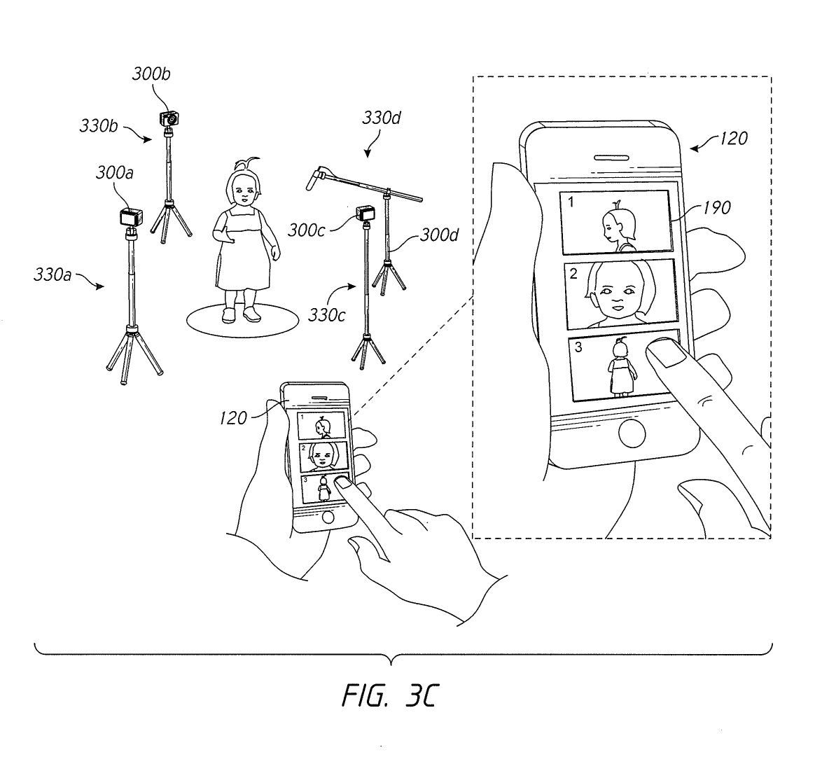

FIGS. 3A-3D illustrate examples of a photographic accessory in the form of a mobile camera device 300 that may be used with a mobile device 120. In some embodiments, the mobile camera device 300 may include an onboard camera or onboard camera lens 302, an onboard or internal processor, a memory, a wireless communication module, a power supply such as a rechargeable battery, and/or one or more photographic altering or enhancing devices or components, such as a flash element 304 or a lighting element (such as a photographic soft-glow lamp, a photographic reflector, a photographic diffuser, and/or a photographic filter, etc.), and/or various other components. A mobile device 120 may communicate with one or more mobile camera devices 300 in a manner that is the same as or similar in any respects to the communication with the remote trigger systems 200 described in this specification. A mobile device 120 may communicate with and control the camera devices 300 using wireless communication technology, such as Bluetooth®. For example, as shown in FIG. 3C, a single mobile device 120 may be configured by an application 190 running on the mobile device 120 to establish a wireless connection with various mobile camera devices 300, to exchange wireless communications with the mobile camera devices 300, to modify photographic and other operational settings, to activate the mobile camera devices 300, to capture photos, video, and/or sound, and/or to generate lighting and/or flashes, etc.

In some embodiments, the mobile camera devices 300 may be shaped and/or sized to enhance or maximize portability. For example, a mobile camera device 300 may be smaller than the mobile device with which it is used (e.g., less than or equal to about: half as wide and/or half as long). The portability of the mobile camera devices 300 can allow a single user to carry a plurality of mobile camera devices 300 in a pocket, back, or case, to a desired location.

In some embodiments, as illustrated in FIG. 3C, a user may mount multiple (e.g., two or more) mobile camera devices 300A, 300B, 300C on tripods 330a-d or place the mobile camera devices on various surfaces to create a mobile studio capable of recording images, video, and/or sound of a subject from various angles. An application 190 may be installed on or provided with a mobile device 120 for controlling and monitoring the various mobile camera devices 300 as described above. The application may provide real-time or recorded displays of each mobile camera device's 300 field of view, allow the user mix and edit images, video, and/or sound from each of the mobile camera devices 300 into a one or more presentations, etc.

In some embodiments, as shown in FIG. 3D, an electrical source and/or connection, such as a dock 320, may be provided to charge an internal battery of mobile camera device 300, transfer data to and/or from the mobile camera device 300 or other computing device, and the like. The dock 320 may include one or more wired electronic contacts (not shown) for communicating with one or more mobile camera devices 300 when the devices are attached to the dock 320. The dock 320 may include multiple ports or contacts for accepting multiple mobile camera devices 300 as shown in FIG. 3D. A data or power connector port for accepting a cable, such as a mini USB port, a micro USB port, a Lightning® port, or the like, may be provided on dock 320, and thus the mobile camera device 300, to facilitate wired electronic communication of data and/or transfer of electronic power. In some embodiments, dock 320 may include an indicator such as a light (e.g., an LED), a speaker, and/or a screen, for indicating statuses and/or other information. The indicator may be indicative of an electrical connection between the mobile camera device 300 and dock 320, a recharge complete status of the battery of the mobile camera device 300, a data transfer status, or any status of electrical communication between the mobile camera device 300 and dock 320 and/or an external unit (not shown).

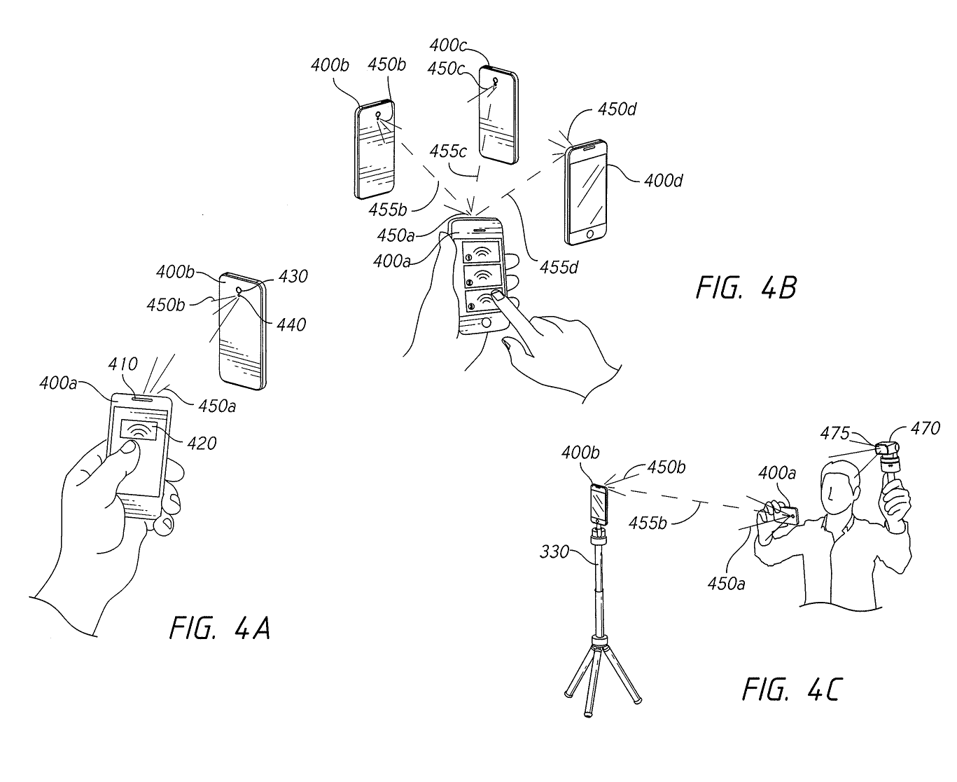

FIGS. 4A-4C illustrate mobile devices communicating wirelessly to exchange information, synchronize operation, remotely activate features, and the like. For example, one mobile device 400A (the “master” mobile device) may emit wireless signals that are received and processed by one or more additional mobile devices 400B-400D (the “slave” mobile devices). In response, the slave mobile devices 400B-400D may perform some function, such as taking a photograph, emitting a flash, launching an application, or some other function. The particular form of “wireless” communication between the mobile devices is not limited to traditional wireless networking (e.g., Bluetooth®, WiFi). Rather, the mobile devices may also or alternatively communicate sonically, luminously, via motion detection, or via other wireless means.

In some embodiments, as shown, mobile devices may include various input and/or output components, such as a speaker 410, an onboard camera 430, a flash 440, microphone (not shown), some combination thereof, etc. A software application 420 may be installed on or provided with one or more mobile devices 400A, 400B. The application 420 may allow a mobile device, such as a master mobile device 400A, to communicate with another mobile device, such as a slave mobile device 400B, to operate the camera 430 and/or flash 440 of the slave mobile device 400B, or to cause the slave mobile device 400B to perform some other function. For example, when communicating using a wireless networking protocol such as Bluetooth®, each mobile device may include a Bluetooth® transceiver that performs the functions of both a transmitter and a receiver. In some embodiments, when communicating sonically, a mobile device may use a speaker 410 to perform the functions of a wireless transmitter, and another mobile device may use a microphone to perform the functions of a wireless receiver. In some embodiments, when communicating luminously, a mobile device may use a flash 440 or display screen to perform the functions of a wireless transmitter, and another mobile device may use a camera 430 to perform the functions of a wireless receiver.

The application 420 may cause the master mobile device 400A to emit a single wireless signal or a sequential pattern of wireless signals. A corresponding application 420 may be installed on the slave mobile device 400B, and may configure the second mobile device 400B to recognize the wireless signal. As described above, the specific wireless signal may be a traditional wireless networking signal, such as a Bluetooth® or WiFi signal. In some embodiments, the application 420 of the master mobile device 400A may cause the speaker 410 to emit a sound or sequence of sounds, and the corresponding application 420 of the slave mobile device 400B may receive the sound or sequence of sounds (or data derived therefrom) from the microphone of the mobile device 400B. The application 420 may process the sounds or sound data and determine that they relate to a command to activate a particular feature, such as a flash 440. In response, the application 420 may cause the slave mobile device 400B to activate the flash 440. In some embodiments, the application 420 of the master mobile device 400A can additionally or alternatively cause a flash component (not shown on the master mobile device 400A) to emit a single flash or a sequence of flashes 450A. The corresponding application 420 of the slave mobile device 400B may receive the flash or sequence of flashes 450A (or data derived therefrom) along line of sight 455B from the camera 430 of the mobile device 400B, and process the flashes or flash data 450A similar to the sound processing described above.

Different wireless signals can provide different benefits. For example, wireless networking signals, such as signals transmitted according to the Bluetooth® standard, may be transmitted by a master mobile device 400A to a slave mobile device 400B that is not within the line of sight 455B of the master mobile device 400A (e.g. to a slave mobile device 400B that is in another room, that is obscured within a container such as a hand bag, etc.). The use of sound signals can provide similar benefits. Light signals (e.g., flashes, infrared light), on the other hand, are typically only received by a slave mobile device 400B that is within the line of sight 455B of a master mobile device 400A transmitting the light-based signals. However, light-based signals may be used in noisy environments, and in situations when wireless networking via Bluetooth® or some other wireless networking standard is not possible or practical (e.g., when one or both of the mobile devices 400A, 400B are not configured or otherwise capable of such standardized wireless networking).

Selection of a master device, or identification of a device as a master or a slave, may be performed explicitly, such as when a user specifies a particular device as the master and other devices as slaves. The master/slave determination may also or alternatively be implicit, such as when a user uses a particular device to establish a communication session. In this example, other devices that join the communication session or subsequently communicate with the master may automatically become slaves. In some embodiments, the master/slave distinction may be transitory or may be made on an ad hoc basis. For example, a user may use a particular device to transmit commands or messages to some other device. In this example, the sending device may be the master and the target of the message or command may be a slave. However, the slave device may subsequently send a message or command to the master device, and the devices may effectively swap roles.

In some embodiments, as shown in FIG. 4B, more than two mobile devices may be synchronized or otherwise configured to communicate using the various wireless methods described above. A user may arbitrarily choose any device to operate as the master, and the remaining devices may automatically become slaves. The choice of master and slave devices may be permanent, may be maintained until changed by a user, or may be temporary (e.g., only maintained for one particular communication session). The user may use an application 420 on one of the mobile devices to select or set the master device. A wireless signal may be transmitted to the other devices configured to identify the master device or to instruct the other devices that they are slaves. In some embodiments, a user may use the application 420 on each mobile device identify the device as either a master or slave, or to set which device is to be the master of a current device.

The example interactions described above are illustrative only, and are not intended to be limiting. In some embodiments, mobile devices may use the application 420 and the various wireless transmitters and receivers described above to exchange information and send commands regarding any function that can be performed by the mobile device, including but not limited to taking a photograph, emitting a flash, recording video, recording sound, playing music, launching or activating another application, presenting some user-perceived output, etc. In some embodiments, a mobile device may be configured to recognize multiple (e.g., two or more) different sequences of wireless input and perform different functions responsive to the particular input received. For example, the mobile device can determine a particular message or command that corresponds to some specific input, and perform a function based on the determined message or command.

In some embodiments, as illustrated in FIG. 4C, a mobile device or group of mobile devices may be configured (e.g., by applications 420 executing thereon) to recognize commands and trigger functions based on input received from sources other than mobile devices. For example, a mobile device 400B executing an application 420 may recognize a single flash or a particular sequence of flashes 475 from element 470, which may represent one or more flashlights, stand-alone camera flashes, vehicle headlights, light bulbs, strobe lights, lightning, combustion (e.g., fires), flares, fireworks, explosions, etc. For example, the mobile device 400B may detect a flash or sequence of flashes 475 or from master mobile device 400A, and relay flash 450B from the camera 440 of mobile device 400B. The relay flash 450B may be indicative that mobile device 400B has received flash 475 or 450B and activated one or more functions of the application included in mobile device 400B. Such functions may include automatically taking a photographic image, recording a video, turning on/off the mobile device 400B, or any other function programmed into mobile device 400B based on the application included in mobile device 400B. As another example, a mobile device 400B executing an application may recognize a single sound or a particular sequence of sounds from a speaker, user (e.g., voice), musical instrument, tone generator (e.g., a tuning fork), environmental noise, thunder, explosions, etc. In certain embodiments, a mobile device may be configured to recognize and respond to input from only specific light sources based on characteristics of the light (e.g., color, hue, intensity, etc.), or from only specific sound sources based on characteristics of the sound (e.g., tone, pitch, volume, etc.)

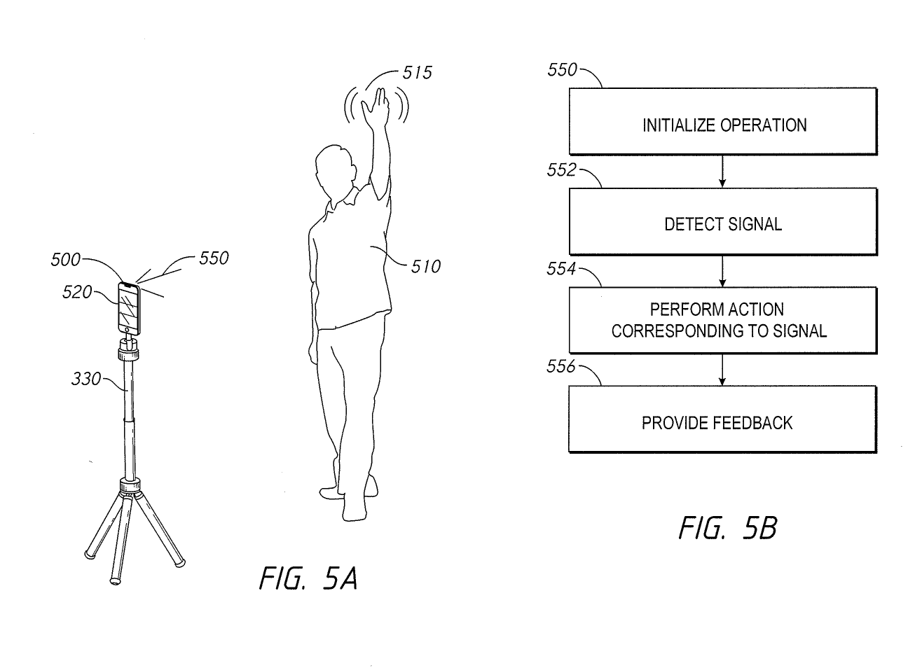

FIG. 5A shows an example of a mobile device 500 configured to perform one or more functions in response to a user signal, such as a user action or a subject action (e.g., one or more gestures or other movements and/or sounds). In some embodiments, as shown, the mobile device 500 may be identical or similar in any respects to other mobile devices described herein. For example, the mobile device 500 may include a flash component and a camera (not shown). An application 520 may be installed on or provided with the mobile device 500. The application 520 can configure the mobile device 500 to recognize one or more specific gestures 515 (e.g., arm movements, hand movements, etc.), one or more sounds, or other actions of a subject or a user 510. For example, the camera of the mobile device 500 may record a stream of video or record images according to some predetermined or dynamically determined interval. The application 520 or some other module or component of the mobile device (e.g., a “listener” service operating in the background that detects an event in data and triggers another application or service in response to detection of the event) can process the camera input and determine whether it contains evidence or an indication of a subject or a user 510 providing some predetermined signal. Upon recognition of the signal, the application 520 can cause the mobile device 500 to perform some action, such as activating a photo timer; capturing an image; emitting a flash; activating, deactivating, and/or changing the hue and/or intensity of a photographic light, filter, and/or reflector; launching an application; and/or performing any other function that the mobile device 500 is capable of performing. In some embodiments, the mobile device 500 may provide feedback to the user 510 indicating that the subject or user signal has been recognized and/or that a particular function has been performed. For example, the mobile device 500 may emit a flash 554 or a sound, and/or display an image on a screen.

FIG. 5B is a flow diagram of an illustrative process for implementing a signal-recognition (e.g., from a user or a subject) feature on a mobile device 500. At block 550, a user or a subject may initiate the application 520 (or some portion thereof) on the mobile device 500. In some embodiments, the operation may be initiated by a user or other mobile device 500 performing or providing one or more signals that the mobile device 500 is preprogrammed to recognize. For example, the mobile device 500 may monitor a scene including a subject or user 510, the subject or user may perform a specific gesture 515 that the application 520 and/or mobile device 500 recognizes as a signal to initiate one or more functions programmed into application 520. At block 552, the mobile device can detect the signal, such as the specific gesture 515. The application 520 can optionally provide a first feedback, such as a flashing light to indicate that the device has detected and recognized the signal. The light may flash according to some specific pattern or sequence to convey recognition of the signal to the user. At block 554, the mobile device 500 can perform the action that corresponds to the signal. For example, after the application 520 and/or mobile device 500 detects the signal, the application 520 may cause the mobile device 500 to perform the one or more functions corresponding to the signal, such as but not limited to taking a picture, turning on the flash, turning on the mobile device 500, or operating any application or function associated with the specific signal. At block 556, the mobile device can optionally provide a second feedback to the user, such as a flash or sequence of flashes indicating that the function has been performed. The second feedback may be the same as the first feedback indicative of detecting the signal. The second feedback may also or alternatively be different than the first feedback, such that a user may be able to distinguish between the separate feedbacks.

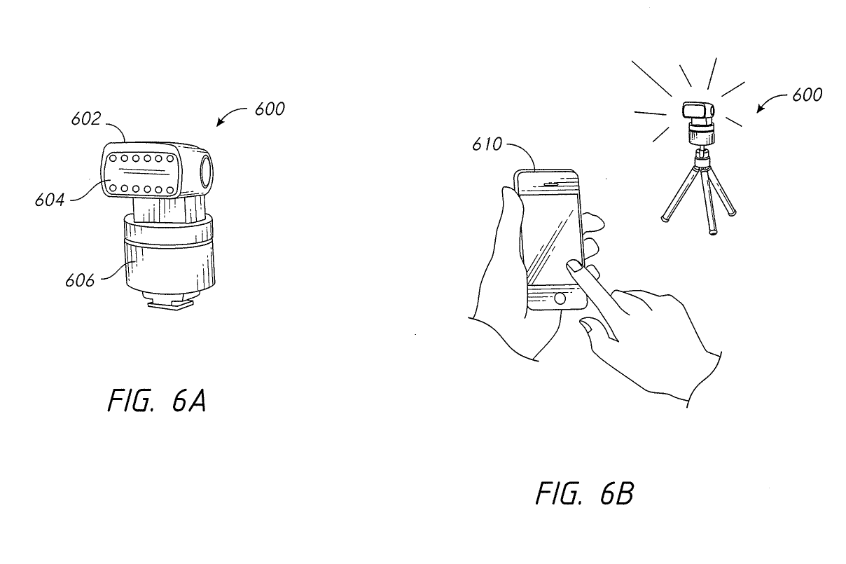

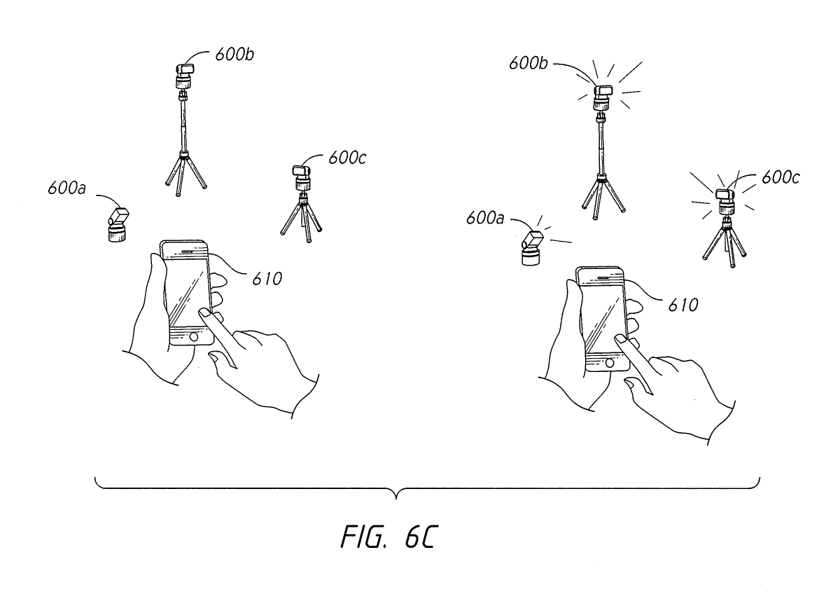

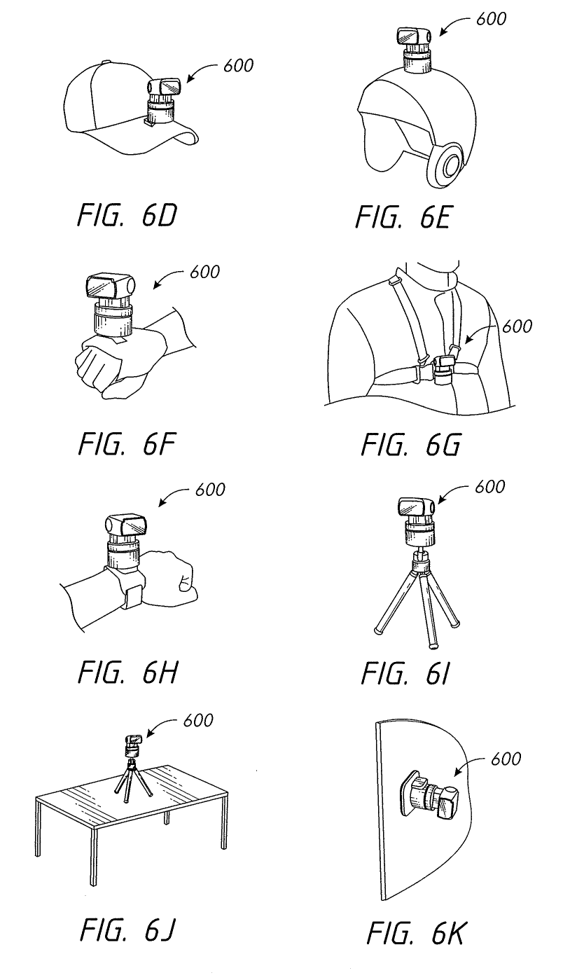

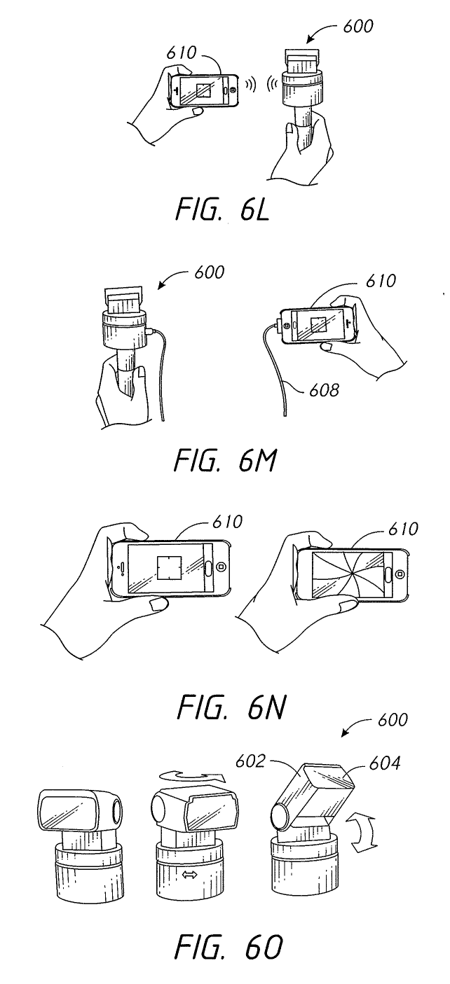

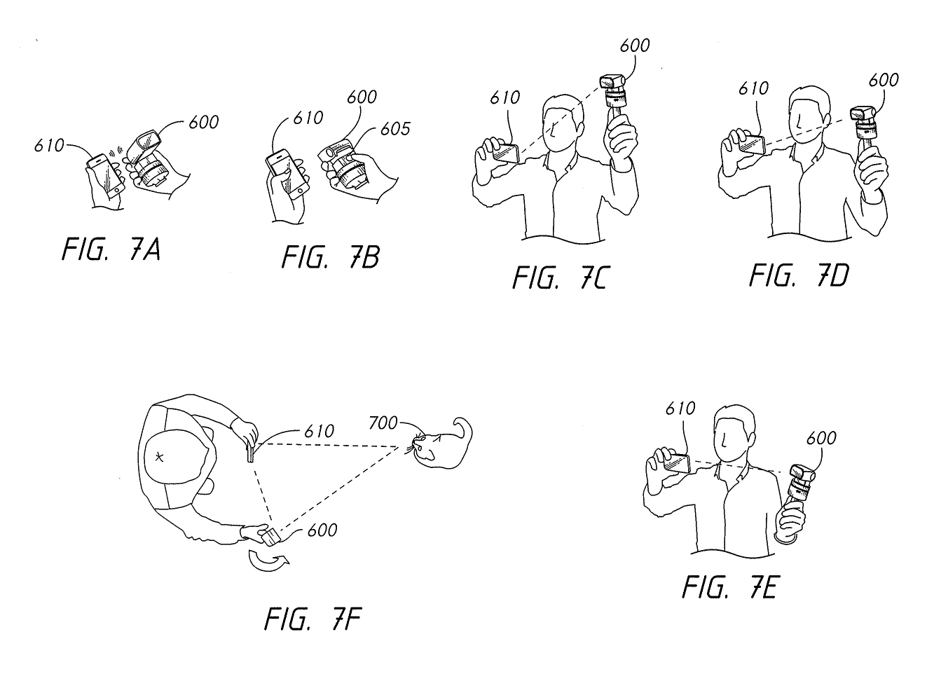

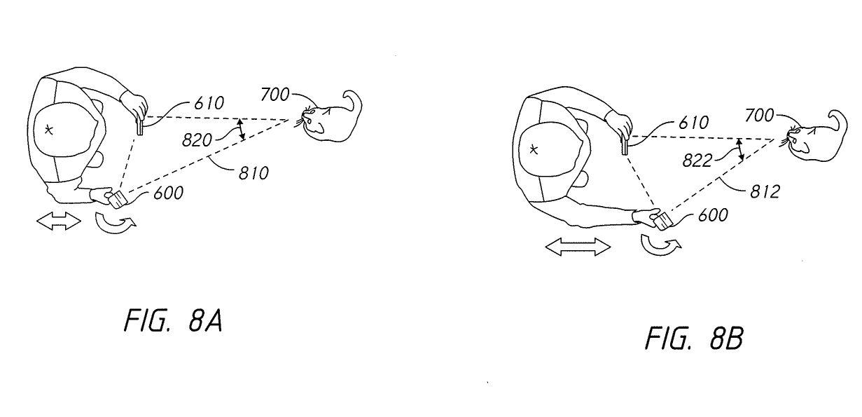

FIGS. 6A-6O and 7A-7-7E illustrate a smart lighting and/or smart flash system 600 that can automatically adjust one or more operational parameters (e.g., the physical position and/or orientation of the lighting or flash system, characteristics of the light to be emitted, etc.) based on information obtained from sensors in the lighting or flash system 600, from a mobile device 610, and/or from other data sources. In some embodiments, as shown in FIGS. 6B and 6C, the lighting or flash system 600 may be a stand-alone device that is configured to provide illumination for use in photography, videography, and other situations. A separate mobile device 610, such as a mobile device with an onboard camera lens or a mobile device configured to use the camera system described above with respect to FIG. 1, may communicate with the lighting or flash system 600 in order to obtain desired lighting or flash for the current situation. For example, a mobile device 610 may determine the distance between the mobile device 610 and the subject to be photographed. The mobile device 610 may also determine the distance between the lighting or flash system 600 and the subject. The mobile device 610 can calculate desired operational parameters for the lighting or flash system 600, such as intensity, duration, hue, and/or direction, etc., and transmit information about the desired lighting or flash parameters to the lighting or flash system 610. The lighting or flash system 610 can then implement the desired operational parameters and emit an optimal or desired flash.

Referring to FIG. 6A, the lighting or flash system 600 may include a head portion 602 that is movable with respect to a base portion 606. The head portion 602 can house a flash element 604, such as an LED, a xenon-based bulb, or some other flash element known to those of skill in the art. The lighting or flash system 600 may include various sensors or other components for determining orientation, position, and/or other information, etc. For example, the lighting or flash system 600 may include a gyroscope, accelerometer, a local positioning system module, a global positioning system (“GPS”) module, and/or a compass. Information about the lighting or flash system 600 can be obtained via the sensors, and provided to a computer, such as a mobile device 610 or an internal or onboard processor. The lighting or flash system 600 may also include one or more adjusters, such as one or more servomechanisms (“servos”) or motors for implementing physical adjustments (e.g., the position and/or orientation with respect to the subject or scene, and/or other characteristic of the lighting or flash system 600), as shown in FIG. 6O. The lighting or flash system 600 may include a battery to power the sensors, adjusters, flash element, lighting element, and/or other electrical components. In some embodiments, as shown in FIG. 6M, the lighting or flash system 600 may include a power cable 608 to draw electrical power from a mobile device 610 or from a standard power source (e.g., a wall outlet). Cable 608 may also facilitate data connectivity and control of lighting or flash system 600 by the mobile device 600. As shown in FIG. 6M, the lighting or flash system 600 may utilize cable 608 to power mobile device 600. In some embodiments, the lighting or flash system 600 may include activation input 605, such as a button or other touch sensitive surface, for activating the lighting or flash system 600 and electronics contained within the lighting or flash system 600, as will be described in more detailed with reference to FIG. 7A.

As shown in FIGS. 6D-6K, the lighting or flash system 600 may be held by a user during operation, placed on a surface (e.g., a table or floor), or mounted in a temporary or permanent location. For example, the lighting or flash system 600 may be mounted to a tripod, headwear that may be worn by a user (e.g., a hat or helmet), other wearable mounts (e.g., a wrist mount, hand mount, necklace), a wall or ceiling, etc.

The lighting or flash system 600 may communicate with the mobile device 610 via wireless means, as shown in FIGS. 6B, 6C, and 6L, such as wireless signals transmitted in accordance with the Bluetooth® standard or using other wireless techniques described herein or known to those of skill in the art. In some embodiments, the lighting or flash system 600 may communicate with the mobile device 610 via a wired connection, such as a cable 608 that is coupled to a port of the flash system 600 and a corresponding port of the mobile device 610, as shown in FIG. 6M. In some embodiments, illustrated in FIG. 6C, multiple lighting or flash systems 600 may communicate with a single mobile device, multiple mobile devices may control a single lighting or flash system, multiple lighting or flash systems may be used with multiple mobile devices, etc. For example, a user may use a mobile device control multiple lighting or flash systems 600, having each of the lighting or flash systems 600 emit a flash in a desired sequence or simultaneously, depending upon the needs of the user.

FIGS. 7A and 7B illustrates an example of a lighting or flash system 600. The lighting or flash system 600 and mobile device 610 may execute an initial startup or synchronization procedure whereby an application on the mobile device 610 determines a starting position and orientation for the mobile device 610 and lighting or flash system 600. For example, the lighting or flash system 600 may be placed near or touched to the mobile device 610 so that the two devices occupy substantially the same space. In some embodiments, lighting or flash system 600 includes activation input 605, such that a user may operate the activation input 605 to power on the lighting or flash system 600 and generally simultaneously, prior, or following operate the application on mobile device 610 to locate, communicate, and synchronize lighting or flash system 600 with mobile device 610. Information from the sensors of the flash component 600 may be provided to the mobile device 610 so that the sensors on the two devices can be synchronized and a starting location for each can be determined. For example, as illustrated in FIGS. 7C-7E, the flash component 600 may be positioned in multiple locations relative to the mobile device 610. The flash component 600 may send sensor readings or calibration signals, such as a signal or sequence of flashes of light, to mobile device 610 at each of the multiple locations. The mobile device 610, or application therein, may receive the sensor readings or calibration signals to further synchronize and calibrate control and operation of flash component 600. The subsequent sensor readings can be compared to initial measurements in order to determine how the position or orientation of the lighting or flash system 600 has changed. A user may activate some input control (e.g., a button displayed by an application) to begin use of the lighting or flash system 600, such as beginning a lighting or flash “session.”

The user may then begin using the mobile device 610 and lighting or flash system 600 to take photographs. The lighting or flash system 600 may detect its current position and orientation using one or more internal sensors and/or data obtained from a mobile device 610. For example, the lighting or flash system 600 can use a gyroscope, accelerometer, compass, and/or other sensors to determine a vertical position (e.g., height) or a change in vertical position, a horizontal position or a change in horizontal position, a direction (e.g., north/south/east/west), and/or an orientation (e.g., tilt). The lighting or flash system 600 can transmit data regarding the current position and orientation to the mobile device 610 at the request of the mobile device 610 (e.g., in response to a command initiated by an application executing on the mobile device 600), according to some predetermined or dynamically determined schedule, in response to some event (e.g., in response to detecting a change in position exceeding some threshold), or the like.

Referring to FIG. 7F, the mobile device 610 may include an application that can calculate and transmit information regarding the optimum or desired position and orientation of the lighting or flash system 600 with respect to a photographic subject 700. In some embodiments, the mobile device 610 can determine a distance between the lighting or flash system 600 and the subject 700 to be photographed using triangulation. The mobile device 610 can determine the location of the subject 700 to be photographed using information about the location and orientation of the mobile device 610 (e.g., obtained using a sensor, GPS unit, compass, etc.) and information about the distance between the mobile device 610 and the subject 700 to be photographed (e.g., based on information determined during auto-focus processing). The mobile device 610 can also determine the location of the lighting or flash system 600 based on the information obtained from the lighting or flash system 600 as described above, in reference to FIGS. 7C-7E. Once the locations of the mobile device 610, lighting or flash system 600, and subject 700 to be photographed are determined, the mobile device 610 can determine optimal or desired parameters for the lighting or flash system 600 and instruct the lighting or flash system 600 accordingly.

The lighting or flash system 600 can activate an adjuster, such as a servo (e.g., rotary actuator, linear actuator) to adjust the angle of the head portion 602 with respect to the base portion 606, and therefore to adjust the angle of the flash element 604 with respect to the photographic subject 700. Alternatively or in addition, the mobile device 610 can sense, calculate, solicit from the user, and/or transmit information regarding the optimum or desired lighting or flash characteristics to the lighting or flash system 600. The lighting or flash system 600 can then adjust the color, hue, intensity, duration, and other light-related or flash-related parameters. The lighting element or flash element can then be controlled and/or triggered from the mobile device 610, such as when the mobile device 610 is taking a picture.

As shown in FIGS. 8A and 8B, the position and orientation of the lighting or flash system 600 may change from a first distance 710 between the lighting or flash system 600 and a photography subject 700 to a second distance 712. The angle 720 formed by the lighting or flash system 600, photography subject 700, and mobile device 610 may also change to a second angle 722. Sensor readings or other information regarding the current position and/or orientation of the lighting or flash system 600, and/or sensor readings or other information regarding the change in distance and/or angle with respect to the subject 700, may be transmitted from the lighting or flash system 600 to the mobile device 610. The mobile device 610 can then determine various modifications to operational parameters of the lighting or flash system 600 to achieve one or more optimal or desired lighting effects, such as any of those described elsewhere herein. In some embodiments, the position of the mobile device 610 may change such that the distance between the mobile device 610 and the subject 700 is changed. The mobile device 610 can determine various modifications to the orientation or other operational parameters of the lighting or flash system 600 to achieve one or more optimal or desired lighting or flash effects, as described elsewhere in this specification. In some embodiments, a user may change the orientation of the mobile device 610 in order to photograph or record a different subject. The mobile device 610 can triangulate or otherwise determine the distance between the lighting or flash system 600 and the new subject based on information inputted or received by the user and/or other information as described elsewhere herein. The mobile device 610 can then determine various modifications to the orientation and/or other operational parameters of the lighting or flash system 600 in order to achieve one or more optimal or desired lighting or flash effects with respect to the new subject.

In some embodiments, the mobile device 610 may calculate one or more optimum or desired operating parameters for the onboard camera and/or flash based on state information associated with the various devices and/or environmental factors, etc. For example, as illustrated in FIG. 6N, an application on the mobile device 610 can determine an optimum or desired time at which to activate the lighting or flash element 604 and/or the camera of the mobile device based on an analysis of “shake” caused by a user's body (e.g., an unsteady hand). The application may use information from an internal accelerometer of the mobile device to determine or predict the shaking of the mobile device 610. Based on that determination, the application can time the camera shutter so that it takes the photo at a desired “still” moment (no movement or lower-rate movement period). A flash emitted by the flash system 600 can be coordinated to also fire at the proper moment. As a result, the application may delay the photo capture, such that the application may not necessarily take the photo at the instant when the user presses the shutter button, but instead at some time thereafter (e.g., a second later, or a fraction of a second later), once the application has determined that it is a preferred or optimal moment to take the picture.

In some embodiments, the lighting or flash system 600 may process sensor information and determine appropriate adjustments to its own operational parameters, rather than receiving instructions or adjustments from a mobile device 610. The lighting or flash system 600 may comprise one or more sensors to enable the lighting or flash system 600 to “be aware” of where it is in relation to the mobile device 610 and the photograph subject 700, such as by automatically triangulating itself, to determine a preferred or optimal timing and direction in which to actuate the lighting and/or the flash based on sensors in the lighting or flash system 600 and/or data obtained from the mobile device 610, etc.

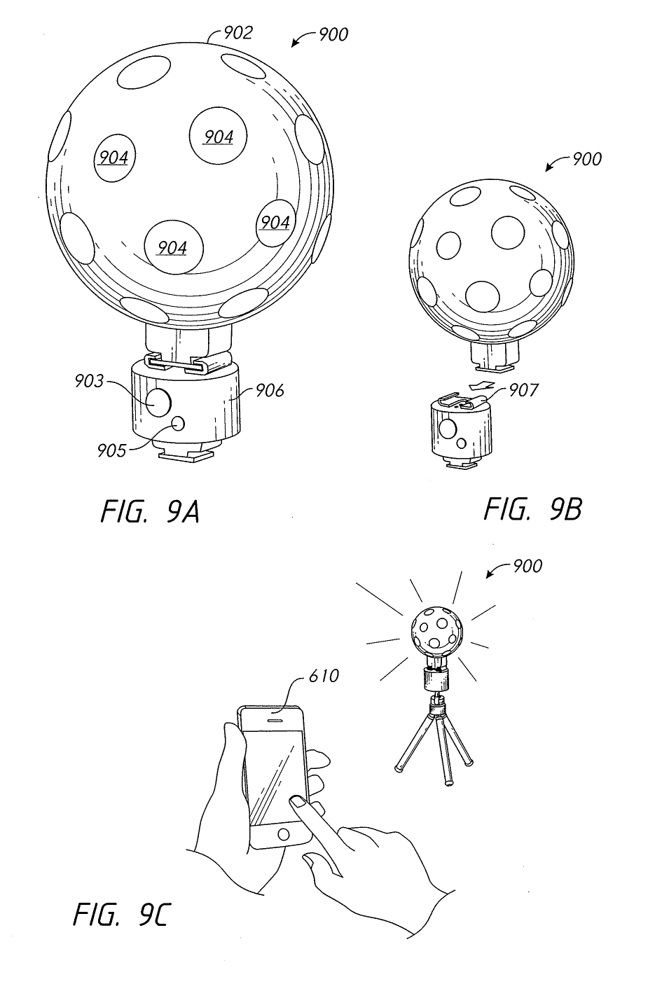

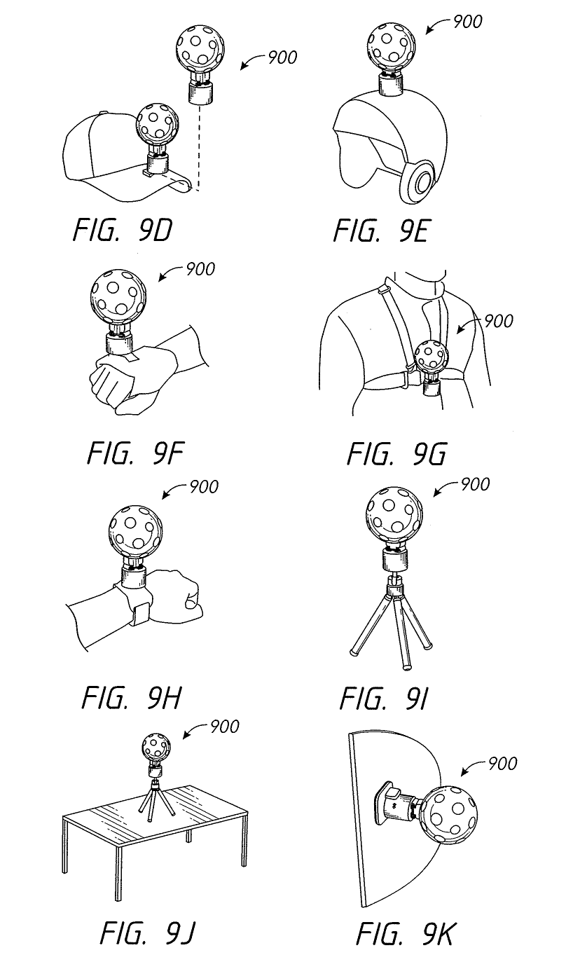

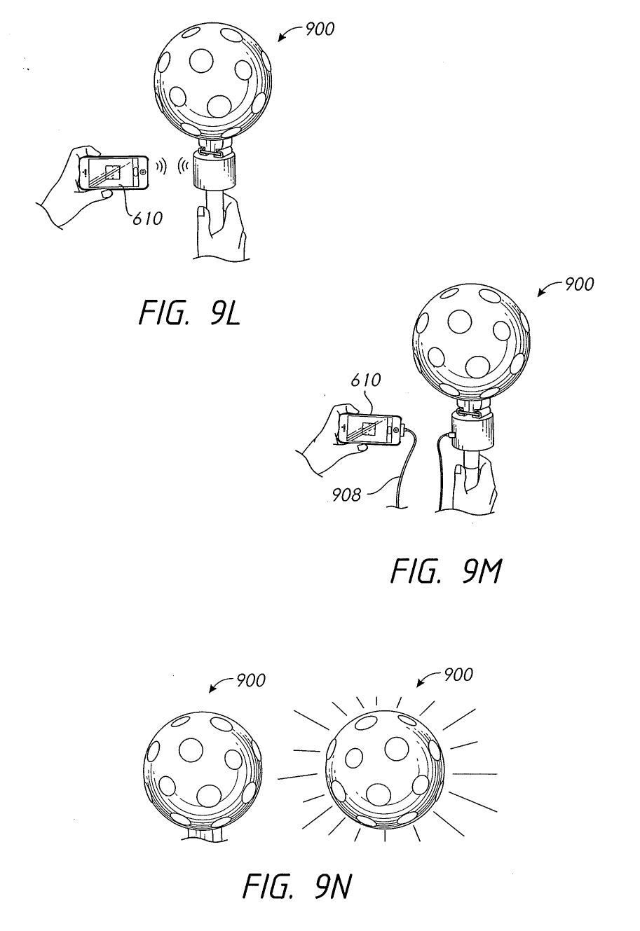

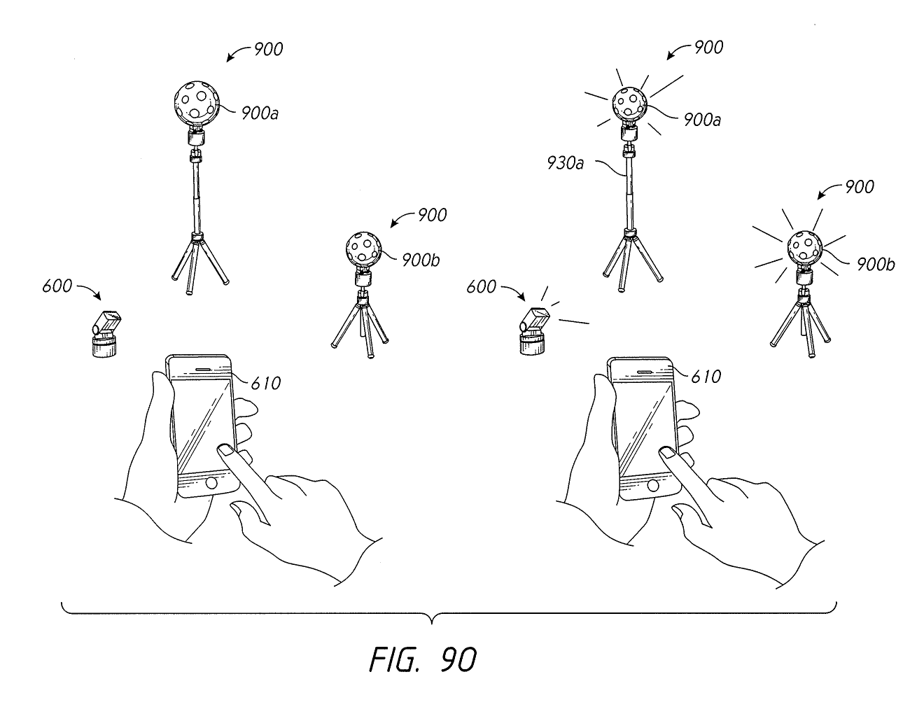

FIGS. 9A-9O illustrate an embodiment of a lighting or flash system 900 with multiple (e.g., two or more) individual lighting or flash elements 904. The lighting or flash system 900 may be similar or identical in any respects to the lighting or flash system 600 described elsewhere herein. For example, the lighting or flash system 900 may include a head portion 902 and a base portion 906. The base portion 906 may include a mating body 907, as illustrated in FIG. 9B, designed for interchangeability of head portions 902, such that a user may change between different types of head portions 907 based on the desired use. The mating body 907 may be an interlocking mount that permits a sliding motion of the head portion 902 along the mating body 907, and once in proper alignment, the head portion 902 may lock or be securely held in place relative to body portion 906 by the mating body 902. The various lighting or flash elements 904 may be positioned on the head portion 902 such that individual lighting or flash elements 904 or groups of lighting or flash elements 904 may be selected to actuate or fire based on the direction in which emission of a light or flash is desired. In some embodiments, as shown, the head portion 902 may be spherical or substantially spherical. Individual lighting or flash elements 904 may be positioned about the head portion 902 to emit light in different directions.

In use, the lighting or flash system 900 can provide (e.g., in a wired or wireless transmission) information to a mobile device 610 about the current position and/or orientation of the lighting or flash system 900, and/or any other information about the lighting or flash system 900 and/or existing lighting conditions or other conditions relating to a subject or scene to be photographed. The mobile device 610 can determine which individual lighting or flash elements 904 should be actuated in order to achieve an optimal or desired lighting or flash effect. The mobile device 610 can transmit instructions to the lighting or flash system 900, and the lighting or flash system 900 can actuate the appropriate flash element 904 or group of flash elements 904. In this way, the head portion 902 does not need to be rotated or angled with respect to a photographic subject. Instead, specific flash elements 904 can be activated on demand or instantly or much faster than if a motor or servo had to re-orient the head portion 902 with respect to the photographic subject. Thus, faster response time can be achieved, resulting in fewer lost opportunities or sub-optimal photos or videos. In some embodiments, various operational parameters of the flash elements 904 may be modified to improve lighting, such as color, intensity, and the like, similar to the modifications described elsewhere herein with respect to the lighting or flash system 600. The operational parameters of the flash elements 904 may be synchronized, or operational parameters of individual flash elements 904 may be set independently of one another to provide additional flexibility and lighting effects.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. It is also contemplated that various combinations or subcombinations of any specific features and aspects of any embodiments may be combined with any specific features of any other embodiments, which still fall within the scope of the invention. Accordingly, it should be understood that various features and aspects of the disclosed embodiments can be combined with or substituted for one another in order to form varying modes of the disclosed invention.

The following is claimed:

1. An auxiliary photographic system that is configured to be used with a mobile communication device, the auxiliary photographic system comprising:
a photographic accessory that is configured to be spaced away from a mobile communication device while in electronic wired or wireless communication with the mobile communication device, the photographic accessory being configured to receive or convey information from or to the mobile communication device.

2. The combination of the auxiliary photographic system of claim 1 and the mobile communication device.

3. The auxiliary photographic system of claim 1, wherein the photographic accessory is a remote camera configured to convey photographic information to the mobile communication device.

4. The auxiliary photographic system of claim 1, wherein the photographic accessory is a photographic altering component configured to alter an image to be captured.

5. The auxiliary photographic system of claim 4, wherein the altering component is a lighting component.

6. The auxiliary photographic system of claim 4, wherein the altering component is a flash component.

7. The auxiliary photographic system of claim 4, wherein the altering component is a filter.

8. The auxiliary photographic system of claim 4, wherein the altering component is a reflector.

9. The auxiliary photographic system of claim 1, wherein the photographic accessory is configured for two-way communication with the mobile communication device to receive commands from the mobile communication device and to convey information to the mobile communication device.

10. The auxiliary photographic system of claim 1, wherein the photographic accessory is configured to change one or more characteristics of the photographic accessory.

11. The auxiliary photographic system of claim 10, further comprising one or more sensors, wherein the one or more characteristics of the photographic accessory can be changed at least in part in response to one or more signals from the one or more sensors.

12. The auxiliary photographic system of claim 11, wherein the one or more characteristics of the photographic accessory can be changed at least in part in response to communication with a mobile communication device.

13. The auxiliary photographic system of claim 11, wherein the photographic accessory is configured to change its position.

14. The auxiliary photographic system of claim 11, wherein the photographic accessory is configured to change its orientation.

15. An auxiliary photographic system that is configured to be used with a mobile communication device, the auxiliary photographic system comprising:
one or more photographic accessories configured to be physically separate from a mobile communication device while in electronic communication with the mobile communication device, the photographic accessory configured to receive one or more commands from the mobile communication device and remotely perform one or more functions of the photographic accessory at least in part in response to the one or more commands; and
one or more sensors configured to detect one or more signals while in communication with the one or more photographic accessories, wherein one or more operational parameters of the photographic accessory are remotely controlled at least in part based on the one or more signals,
wherein an image of a subject is captured based on the performance of the one or more functions and operational parameters.

16. The combination of the auxiliary photographic system of claim 15 and the mobile communication device.

17. The auxiliary photographic system of claim 14, wherein at least one of the one or more photographic accessories is a remote camera configured to convey photographic information to the mobile communication device.

18. The auxiliary photographic system of claim 14, wherein the one or more photographic accessories comprises a plurality of remote cameras configured to convey photographic information to the mobile communication device, and a program configured to enable the mobile communication device to display the photographic information from each remote camera simultaneously on a single display of the mobile communication device.

19. The auxiliary photographic system of claim 14, wherein the one or more signals includes at least one of the following: a user initiated gesture, a light, a sound, a movement of a user, a movement of the photographic accessory, and the activation of one or more functions of the photographic accessory.

20. The auxiliary photographic system of claim 14, further comprising a plurality of photographic accessories configured to be physically separate from the mobile communication device while in electronic communication with the mobile communication device, the plurality of photographic accessories configured to be physically separate from each other, the plurality of photographic accessories configured to receive one or more commands from the mobile communication device and remotely perform one or more functions of the plurality of photographic accessories in response to the one or more commands;
wherein the one or more functions of the plurality of photographic accessories are synchronized at least in part via communication with the mobile communication device.

21. The auxiliary photographic system of claim 20, wherein the plurality of photographic accessories are configured to be in communication with each other while individually in electronic communication with the mobile device.
